(19) United States
(12) Patent Application Publication
(10) Pub. No.: US 2007/0210663 A1
(43) Pub. Date: Sep. 13, 2007

(54) Electric motor having a rotor, rotor and process for manufacturing a rotor for an electric motor

(76) Inventors: Michal Kalavsky, SK-Zombova (SK); Kurt Wallerstorfer, Strasswalchen (AT); Gerhard Oswald, Wangen/Haslach (DE)

Correspondence Address: William D. Breneman, Esq.;BRENEMAN & GEORGES, 3150 Commonwealth Avenue, Alexandria, VA, 22305, US

(21) Appl. No.: 11/730,117

(22) Filed: Mar. 29, 2007

(30) Foreign Application Priority Data
Mar. 13, 2006 (DE) 10 2006 015 534.3
Aug. 2, 2006 (DE) 10 2006 036 392.2

(51) Int. Cl. H02K 1/27

(52) U.S. Cl. 310/156.19; 310/43; 310/156.23

(57) ABSTRACT

The invention proposes an electric motor having a rotor, a rotor and a process for manufacturing a rotor for an electric motor, in which the manufacturing complexity is considerably reduced in comparison with the prior art. This object is achieved by virtue of the fact that, in the rotor, a plastics connection (11, 12) is provided between the return plate (2) and the rotor shaft (1). This plastics connection (11, 12) between the return plate (2) and the rotor shaft (1) is produced in accordance with the manufacturing process according to the invention by injection-molding.

In rotors of permanent-magnet electric motors, permanent magnets are fitted to a so-called return plate, which is connected to a motor shaft. This fixing, in particular of the permanent magnet poles, is generally implemented by an adhesive bond, possibly with the aid of a fixing collar.

This type of rotor manufacture is very complex in terms of assembly in particular in the case of low-power motors. In addition, when using such electric motors in a moist or wet environment, additional complex sealing of the rotor is required.

The object of the invention is accordingly to propose an electric motor or a rotor for an electric motor and a process for its manufacture, with which the manufacturing complexity is considerably reduced.

This object is achieved by the features of claims 1, 11 and 12.

Accordingly, a rotor according to the invention for an electric motor is characterized by the fact that a plastics connection is provided between the return plate and the rotor shaft. Owing to this type of manufacture, precise mutual fixing between the return plate and the rotor shaft and at the same time, via the plastic, an interlocking and also water-tight connection between the motor shaft and the return plate are possible in a single working step which is cost-effective in particular in large production numbers.

The plastics connection can be produced, for example, by an injection-molding step. Such a manufacturing process is largely open, inter alia, to automation.

In one development of the invention, the magnet poles are also fixed by a plastics connection to the return plate. The fixing of the magnet poles can in this case be implemented in a single working step with the connection of the return plate on the rotor shaft or else in a process with two or more stages.

Furthermore, the entire rotor is preferably provided with a plastic casing, through which the rotor shaft passes. This results in a rotor which is completely resistant to moisture or wet, such as may be used, for example, in a wet-rotor pump.

Owing to the use of plastic between the shaft and the return plate, on the one hand, and between the return plate and the magnet poles, on the other hand, such a plastic casing can be fitted without any problems to such a rotor, for example fused with the plastic which is provided in any case.

Such a plastic casing can be realized, for example, in a single manufacturing step using an injection-molding process. However, it may also be injection-molded in a multi-stage process once the rotor shaft has been connected to the return plate in a second or a further process step. Preferably, the plastic casing is at the same time used to fix the magnet poles, the fixing of the magnet poles and the injection-molding of the rotor being performed in one working step. The plastic casing is in this case advantageously fused using the plastic applied in a preceding working step.

In order to achieve a plastic wall which is as thick as possible in the region of the outer contour of the magnet poles, the magnet poles are advantageously beveled in the corners, with the result that the enveloping wall thickness in this region reaches a maximum.

During the manufacture of such a rotor in a multi-stage process, as has already been indicated above, in a first process step together with the plastics connection between the return plate and the rotor shaft, a frame for inserting preferably permanently excited magnet poles is advantageously formed in an injection-molding process.

Such a frame simplifies the positioning and fixing of the magnet poles on the rotor, in a second process step it then being possible to achieve the permanent connection between the magnet poles and the rotor likewise in an injection-molding process whilst fusing the plastics. In the second process step, a plastic casing, as explained above, can at the same time be completely injection-molded around the rotor.

Such a plastic frame can in this case have, for example, undercuts or other latching elements, with the result that, when the magnet poles are inserted, they can be pushed into the plastic frame over a latching point and thus automatically fixed.

The insertion of the magnet poles is in this case preferably performed outside the injection-molding die. As a result, the magnet poles can be handled gently in a separate mounting step, as a result of which they are protected against any damage, for example against scratches or the like.

For the injection-molding in the second process step, the injection-molding points are advantageously arranged centrally with respect to the magnet poles, with the result that said magnet poles are pressed onto the return plate owing to the injection-molding pressure with a pressure directed uniformly radially inward and therefore a largely concentrically running and balanced rotor is produced.

Advantageously, cutouts, such as annular grooves or the like in the rotor shaft or else knurling or fluting in the shaft surface, are proposed as the fixing elements between the rotor shaft and the return plate. Ribs, drilled holes or the like can also be used for this purpose. Such structures as fixing elements are intended to improve the force transfer between the motor shaft and the return plate, i.e. to counteract rotation and to counteract axial displacement.

In order to position the return plate in the injection-molding die, it is preferably provided with positioning elements, for example with drilled holes for accommodating positioning pins or the like. The positioning of the return plate in the axial direction is advantageously provided via a stop in the die.

Furthermore, in the manufacturing process according to the invention, simple compensation for laminate tolerances of the return plate can be achieved. The return plate is preferably formed from a laminate stack, as is conventional in motor construction. The axial length of such a laminate stack can accordingly be varied to a certain extent by compressing the laminate stack with more or less pressure. When injection-molding around such a rotor laminate stack, the laminate stack is therefore advantageously pressed in advance with a press ram against a reference stop, for example a reference edge, with the result that the same outer geometry of the rotor laminate stack is always produced which is maintained by the plastic after the solidification.

One exemplary embodiment of the invention is illustrated in the drawing and will be explained in more detail below with reference to the figures, in which, in detail:

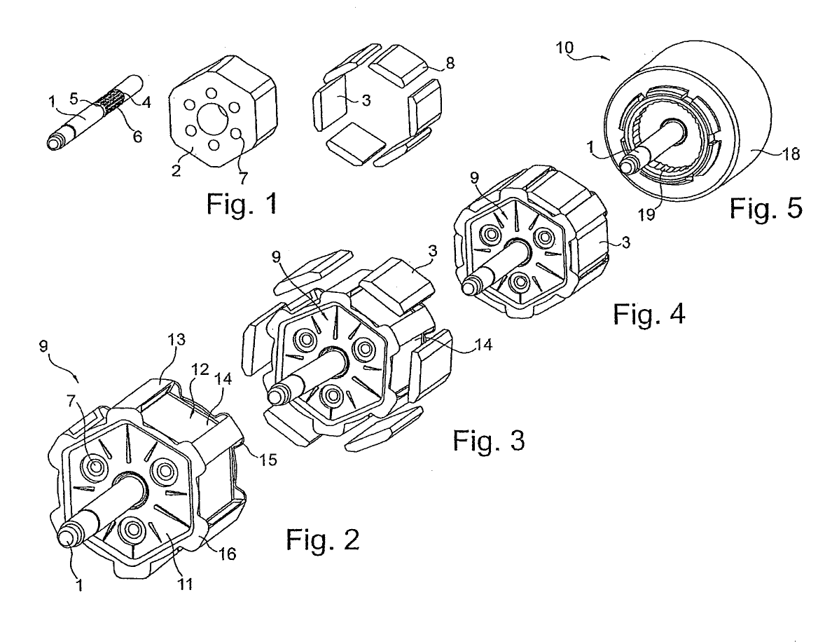

FIG. 1 shows the individual components of a rotor prior to an injection-molding process in a perspective illustration;

FIG. 2 shows an intermediate product after a first injection-molding step in a perspective illustration;

FIG. 3 shows a perspective drawing of the intermediate product shown in FIG. 2 with magnet poles in an exploded illustration;

FIG. 4 shows the intermediate product shown in FIG. 2 with the magnet poles inserted;

FIG. 5 shows a complete rotor after a second injection-molding step;

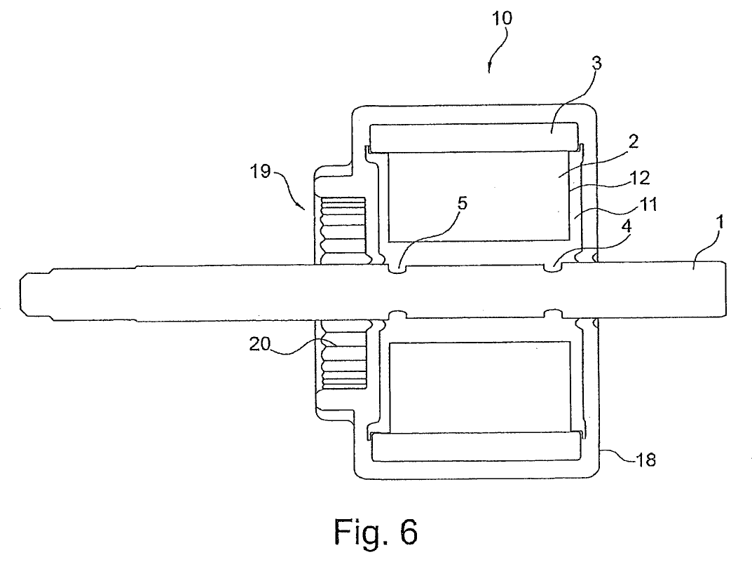

FIG. 6 shows a longitudinal section through a complete rotor shown in FIG. 5, and

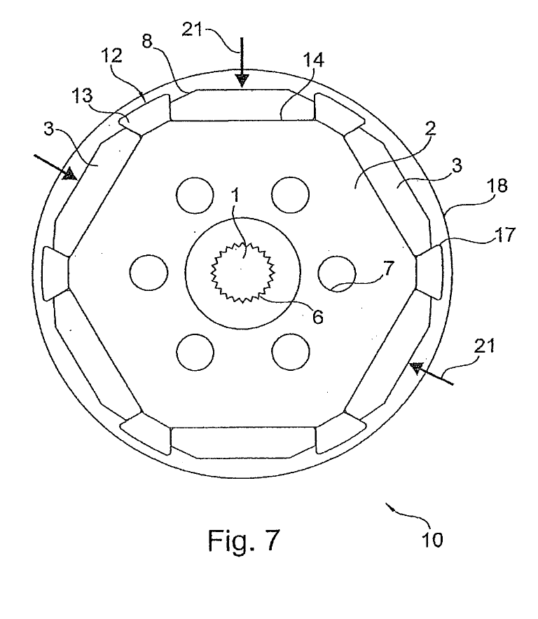

FIG. 7 shows a cross section through a complete rotor shown in FIG. 5.

FIG. 1 shows the rotor shaft 1, a return plate 2 and six magnet poles 3. The rotor shaft 1 is provided with two annular grooves 4, 5 and, in the region lying therebetween, with longitudinal fluting 6. The annular grooves 4, 5 are intended to secure the rotor shaft against axial displacement in the fitted state, while the longitudinal fluting 6 is intended to prevent a rotation.

The return plate 2 of the rotor is formed by a laminate stack, which is shown as an integral object for the purpose of providing a better illustration. The design of such a return plate 2 in the form of a laminate stack is known from motor construction. The return plate 2 is provided with six drilled centering holes 7, which are used for positioning the return plate 2 in the injection-molding die and in particular for centering them with respect to the rotor shaft 1.

The magnet poles 3, which are preferably in the form of permanent magnets, in particular in the form of rare-earth magnets, are provided on their outer contour, in the corner regions, with bevels 8.

In the exemplary embodiment described, in a first process step an intermediate product 9 is produced from the mentioned individual parts, i.e. the rotor shaft 1, the return plate 2 and the magnet poles 3, and, once the magnet poles 3 have been inserted, in a second process step the complete rotor 10 is manufactured from this intermediate product 9.

FIG. 2 illustrates the intermediate product 9. The rotor shaft 1 is arranged centrally in the return plate 2 and has plastic injection-molded around it, only the drilled centering holes 7 of the return plate 2 being shown in the illustration shown in FIG. 2 owing to the injection-molded plastic 11. The injection-molding die is in this case designed such that a plastic frame 12 is produced on the intermediate product 9, which plastic frame has projections 13 and depressions 14. End-side webs 15, 16 are fitted next to the radial projections 13 such that the depressions 14 form troughs, which provide the magnet poles 3 with a hold over their entire circumference and therefore position them reliably.

FIG. 3 illustrates the intermediate product 9 with the magnet poles 3, which have not yet been inserted, but are arranged, in the exploded illustration, directly in front of the trough-shaped depressions 14.

FIG. 4 shows the intermediate product 9 with the magnet poles inserted. In this case, the magnet poles are already fixed since the outer contour of the radial projections 13 is selected such that latching tabs 17 result which latch the magnet poles 3 and, as a result, fix them to the intermediate product 9 (cf. FIG. 7).

This mounting step, in which the magnet poles 3 are inserted into the intermediate product 9, can be performed outside the injection-molding die and therefore in a particularly gentle way for the magnet poles 3. Then, plastic is injection-molded completely around the intermediate product 9 with the magnet poles 3 inserted in a further process step, which results in a plastic casing 18 from which merely the rotor shaft 1 protrudes, which passes through the plastic casing 18.

In the second injection-molding step, the plastic casing 18 is fused with the plastic frame 12 from the first injection-molding step, which results in a virtually integral plastic part, into which the components listed with reference to FIG. 1, i.e. the motor shaft 1, the return plate 2 and the magnet poles 3, are embedded. In the last process step, in the embodiment illustrated at the same time an end-side bearing seat 19 with an inner toothed portion 20 is integrally formed on the rotor 10 and is used for accommodating an end-side bearing. The bearing seat 19 can clearly be seen in FIG. 6 in terms of its configuration with the inner toothed portion 20.

In the cross-sectional illustration shown in FIG. 7, the injection-molding points 21 are illustrated by arrows. They are arranged centrally with respect to the magnet poles 3 and advantageously, in the exemplary embodiment described, such that they are at a right angle to said magnet poles and such that they run radially inward. As a result, when the plastic casing 18 is injection-molded in the second process step, a radially inwardly pointing contact pressure which is distributed uniformly over all the magnet poles 3 is produced such that said magnet poles 3 are pressed uniformly onto the return plate 2 or the intermediate product 9. Owing to this measure, the imbalance of the complete rotor 10 is reduced, with the result that the complete electric motor runs concentrically and with little vibration.

The rotor 10 illustrated and the described process steps show merely by way of example how, with the aid of plastics connections according to the invention between the individual components, i.e. at least between the return plate 2 and the rotor shaft 1, preferably also between the return plate 2 and the magnet poles 3, in simple process steps without any additional mounting parts increasing complexity, a rotor for an electric motor can be manufactured which is extremely suitable in particular for use in a moist or wet environment. One application area for such a rotor is conceivable, for example, as a so-called wet rotor in a water pump. For this or comparable applications, the plastic is preferably selected to be alkali-resistant and thermally resistant and as vapor-tight as possible.

In particular, with the manufacture of a rotor according to the invention, fusing of the plastic results over a large area on the end side and therefore an effective connection between the individual components and the possibility of integrally forming further elements, such as a bearing seat for an end-side bearing, for example, result.

### LIST OF REFERENCE SYMBOLS

| | |
|---|---|
| 1 | Rotor shaft |
| 2 | Return plate |
| 3 | Magnet pole |
| 4 | Annular groove |
| 5 | Annular groove |
| 6 | Longitudinal fluting |
| 7 | Drilled centering holes |
| 8 | Bevel |
| 9 | Intermediate product |
| 10 | Rotor |
| 11 | Plastic |
| 12 | Plastic frame |
| 13 | Radial projection |
| 14 | Depression |
| 15 | Web |
| 16 | Web |
| 17 | Latching tab |
| 18 | Plastic casing |
| 19 | Bearing seat |
| 20 | Inner toothed portion |
| 21 | Injection-molding point |

1. Rotor for an electric motor having magnet poles, a return plate and a rotor shaft, characterized in that a plastics connection (11, 12) is provided between the return plate (2) and the rotor shaft (1).

2. Rotor according to claim 1, characterized in that the plastics connection (11, 12) is injection-molded on.

3. Rotor according to one of the preceding claims, characterized in that the magnet poles (3) are fixed by a plastics connection to the return plate (2).

4. Rotor according to one of the preceding claims, characterized in that a plastic casing (18) surrounds the complete rotor (10), through which merely the rotor shaft (10) passes.

5. Rotor according to one of the preceding claims, characterized in that the plastic casing (18) is injection-molded on.

6. Rotor according to one of the preceding claims, characterized in that all of the plastic elements are shaped integrally.

7. Rotor according to one of the preceding claims, characterized in that the plastics connection (11, 12) between the return plate (2) and the rotor shaft (1) and the plastics connection between the return plate (2) and the magnet poles (3) are produced separately.

8. Rotor according to one of the preceding claims, characterized in that two plastic elements which are fused to one another in a two-stage process are provided.

9. Rotor according to one of the preceding claims, characterized in that the return plate (2) has positioning elements (7) for centering purposes with respect to the rotor shaft (1) prior to the production of the first plastics connection (11, 12).

10. Rotor according to one of the preceding claims, characterized in that the rotor shaft (1) has fixing elements (4, 5, 6) for fixing the rotor shaft (1) in the plastics connection (11, 12).

11. Electric motor having a stator and a rotor, characterized in that a rotor (10) according to one of the preceding claims is provided.

12. Process for manufacturing a rotor for an electric motor having magnet poles, a return plate and a rotor shaft, characterized in that a plastics connection (11, 12) between the return plate (2) and the rotor shaft (1) is injection-molded.

13. Process according to claim 12, characterized in that a plastics connection (18) for the magnet poles on the return plate (2) is injection-molded.

14. Process according to one of the preceding claims 12 to 13, characterized in that, in a first process step, the plastics connection between the return plate (2) and the rotor shaft (1) and, in a second process step, the plastics connection between the magnet poles (3) and the return plate (2) are injection-molded.

15. Process according to one of claims 12 to 14, characterized in that, in the first method step, a plastic frame (12) for inserting the magnet poles (3) is shaped when the first plastics connection is produced.

16. Process according to one of claims 12 to 15, characterized in that, in a second process step, a plastic casing (18) is injection-molded when the plastics connection between the return plate (2) and the magnet poles (3) is produced.

17. Process according to one of claims 11 to 16, characterized in that the return plate (2) is centered with respect to the rotor shaft (1) by means of positioning elements (7) before the first process step.

18. Process according to one of claims 11 to 16, characterized in that the magnet poles (3) are inserted into the plastic frame (12) in a separate mounting step outside the injection-molding die.

19. Process according to one of claims 11 to 17, characterized in that the plastic frame (12) is provided with latching elements (17) for fixing the magnet poles (3).

20. Process according to one of claims 11 to 17, characterized in that injection-molding points (21) are arranged centrally with respect to the magnet poles (3).

21. Process according to one of claims 11 to 17, characterized in that the injection-molding is performed in the region of the magnet poles with a direction of flow of the plastic melt which points radially inward.
